(19) United States
(12) Patent Application Publication
(10) Pub. No.: US 2004/0003030 A1
(43) Pub. Date: Jan. 1, 2004

(54) Mail server with forwarding function and a storage medium storing a program for the mail server

(75) Inventor: Masaaki Abe, Morioka-shi (JP)

Correspondence Address: LOWE HAUPTMAN GOPSTEIN GILMAN & BERNER, LLP, 1700 Diagonal Road, Suite 310, Alexandria, VA, 22314, US

(73) Assignees: EMS Inc.; Masaaki ABE

(21) Appl. No.: 10/183,667

(22) Filed: Jun. 28, 2002

(51) Int. Cl. G06F 15/16

(52) U.S. Cl. 709/203; 713/201

(57) ABSTRACT

A mail server with a forwarding function provided for a company mail server or an ISP mail server with which a user belonging to the company is contracted has at least a user table storing user passwords and the like; an address table storing forwarding addresses for each user; regulating tables for regulating the forwarding time periods of each day and the number of characters in a forwarded e-mail for each forwarding address; and a rejection table for preventing some e-mail from being forwarded based on the contents of the e-mail header or the text. Provided a user is authenticated by a password, the user can assign daily forwarding time periods stored in the table for each of a plurality of terminals, such as a home computer, cellular telephone, or other portable terminal. The user can also input weekly conditions for canceling such forwarding. When the mail server receives e-mail, the server references the rejection table to determine whether the incoming e-mail falls within the forwarding conditions. If the e-mail does fall within the forwarding conditions, the server compares the forwarding time period for the destination terminals with the current time and transfers the e-mail to those terminals that conform to the time condition.

### BACKGROUND OF THE INVENTION

1. Field of the Invention

The present invention relates to a mail server with a forwarding function and a storage medium storing a program for the mail server. The present invention particularly relates to a mail server that can be configured by the user to forward e-mail to a desired terminal during a specified time period, to ignore the specified forwarding time period on a particular day of each week, and the like.

2. Description of the Related Art

With the growing popularity of the Internet, more and more data is being transferred by e-mail. E-mail can be transmitted and received at a user's convenience without concern for the convenience of the person to whom the e-mail is being transmitted or from whom the e-mail is being received. E-mail is not dependent on one particular location, but can be sent to or from the office, home, or current location of the user.

For example, a company computer system with a mail server receives e-mail for users working at the company. If the users are not in the office to receive the e-mail, the e-mail is stacked on a spool and retained. However, there has been no way to forward this e-mail to the user.

A conventional method for solving this problem when the user is out of the office, for example, and has not read the e-mail on the mail server has been to automatically forward the e-mail to a predetermined e-mail address based on an attribute in the e-mail.

This automated forwarding function is implemented on the mail server to determine forwarding conditions based on data for a forwarding terminal and e-mail address specified by the user in advance. The system then automatically forwards the e-mail to a terminal connected to a mail server belonging to an Internet Service Provider (ISP) with which the destination terminal is contracted.

However, it is difficult to set sufficiently detailed forwarding conditions to accommodate each user in order that e-mail users can efficiently receive e-mail addressed to them.

Accordingly, a forwarding function was necessary for a company computer system with a mail server, for example. When a user employed at the company is away from the office during working hours, for example, the mail server forwards the user's e-mail to a terminal connected to the mail server system of an ISP with which the user has a cellular telephone contract. At times outside of working hours, the mail server forwards the e-mail to a terminal connected to a mail server system of an ISP with which the user has a home computer contract. In addition, on public holidays or days of the week the user is not working, the mail server can be switched between canceling mail forwarding or forwarding all e-mail to the terminal connected to the mail server system of the ISP with which the user has a home computer contract.

### SUMMARY OF THE INVENTION

In view of the foregoing, it is an object of the present invention to provide a mail server with a forwarding function comprising at least an e-mail address for each terminal to which the user wishes to forward e-mail, a forwarding time period table for each day, and a rejection table for each terminal. Provided the user is authenticated by a password, the user can set a plurality of terminals (for example, a home computer, cellular phone, and the like) to which the user wishes to forward e-mail and a forwarding time period for each day using these tables. The user can also set conditions for canceling e-mail forwarding on certain days of the week and the like. Upon receiving e-mail, the mail server references the rejection table to determine whether the incoming e-mail meets the forwarding conditions. If the e-mail falls within these conditions, the user-specified time period is compared to the current time in the system, and the e-mail is transferred to a terminal connected to a mail server system of an ISP with which the terminal in the conditions is contracted, thereby enabling the user to receive the user's own e-mail efficiently.

These and other objects will be attained by a mail server with a forwarding function for simultaneously forwarding incoming e-mail addressed to a user to the user's forwarding address and storing the e-mail temporarily on a spool. The mail server with a forwarding function comprises a forwarding time period regulating table storing an e-mail address for each of one or more user terminals used as destinations for forwarding e-mail and storing settings for regulating a prescribed forwarding time period corresponding to each e-mail address or terminal for the 24 hour period of each day; a character number regulating table storing settings for regulating the number of characters in e-mail forwarded to each terminal; a user table storing a password for each user required for accessing the time period regulating table and the character number regulating table as a user; a rejection table recording user-specified forwarding rejection headers and forward rejection character arrays that are referenced when reading the header portions of incoming e-mail; time period forwarding means for referencing the time period regulating table when e-mail addressed to the user is received via a LAN or an internet, reading the forwarding time period for each forwarding destination terminal of the user and the current time, and forwarding the e-mail to a computer system belonging to the Internet service provider of each terminal having a forwarding time period in which the current time falls; forwarding time period regulating table setting/modifying means for prompting the user for a password and authenticating the password based on the user table when an access request to set or update the forwarding time period for the user terminals is received and for receiving a forwarding time period specified by the user and writing the time period to the forwarding time period regulating table if the password is authenticated; character number regulating table setting/modifying means for prompting the user for a password and authenticating the password based on the user table when an access request to set or update the forwarding character number for the user terminals is received and for receiving a forwarding character number (byte number) specified by the user and writing the number to the character number regulating table if the password is authenticated; rejection table setting/modifying means for prompting the user for a password and authenticating the password based on the user table when an access request to set or update data in the rejection table for incoming e-mail is received and for receiving a forwarding rejection header and forwarding rejection character array specified by the user and writing the data to the rejection table if the password is authenticated; and forwarding time period switching means for setting the user-specified forwarding time period to be invalid for specific dates or days of the week specified by the user or to be valid for the entire day on the specific dates or days of the week after the user's password has been authenticated.

There are two methods for controlling the setting and updating specifications for forwarding e-mail to the user's terminals. In one method of control, the user inputs a password for authentication using HTTP via a web browser. In the other method, it is achieved by transmitting control commands from the user's home computer or portable terminal using e-mail addressed to the user.

Further, the forwarding time period switching means further comprises monthly switching means for setting the user-specified forwarding time period to invalid or to valid for the entire day for user-specified days of the month, such as nonworking days, after the user's password has been authenticated.

Further, the mail server is a company computer system at the user's place of work; one of the destination terminals to which e-mail is forwarded is connected to a mail server system of an ISP with which the user is contracted to use a home computer with a web browser; another destination terminal to which e-mail is forwarded is connected to an ISP mail server system with which the user is contracted to use a cellular telephone having an Internet web browser; the forwarding time period for forwarding e-mail to the home computer is set to nonworking hours; and the forwarding time period for forwarding e-mail to the cellular telephone is set to working hours.

Further, the mail server is provided in a company computer system at the user's place of work or in a computer system of an ISP with which the user's company is contracted; one of the destination terminals to which e-mail is forwarded is connected to a mail server system of an ISP with which the user is contracted to use a home computer with a web browser; another destination terminal to which e-mail is forwarded is connected to an ISP mail server system with which the user is contracted to use a cellular telephone having an Internet web browser; the forwarding time period for forwarding e-mail to the home computer is set to nonworking hours; and the forwarding time period for forwarding e-mail to the cellular telephone is set to working hours.

Further, the user can modify the number of characters of e-mail that can be forwarded to the home computer and the cellular telephone.

Further, a storage medium stores programs for a mail server with a forwarding function, comprising the above time period forwarding means, the forwarding time period regulating table setting/modifying means, the character number regulating tablesetting/modifying means, the rejection table setting/modifying means, and the forwarding time period switching means used by the above-described mail server with a forwarding function.

### BRIEF DESCRIPTION OF THE DRAWINGS

In the drawings:

FIG. 1 is a block diagram showing the configuration of a mail server with a forwarding function according to the first embodiment;

FIG. 2 is a block diagram showing the configuration of a mail server with a forwarding function according to the second embodiment;

FIG. 3 shows sample tables for regulating the forwarding time periods, character numbers, and the like; and

FIG. 4 is a flowchart showing the operations of the mail server with forwarding function according to the first embodiment.

### DESCRIPTION OF THE PREFERRED EMBODIMENTS

A mail server with a forwarding function according to preferred embodiments of the present invention will be described while referring to the accompanying drawings.

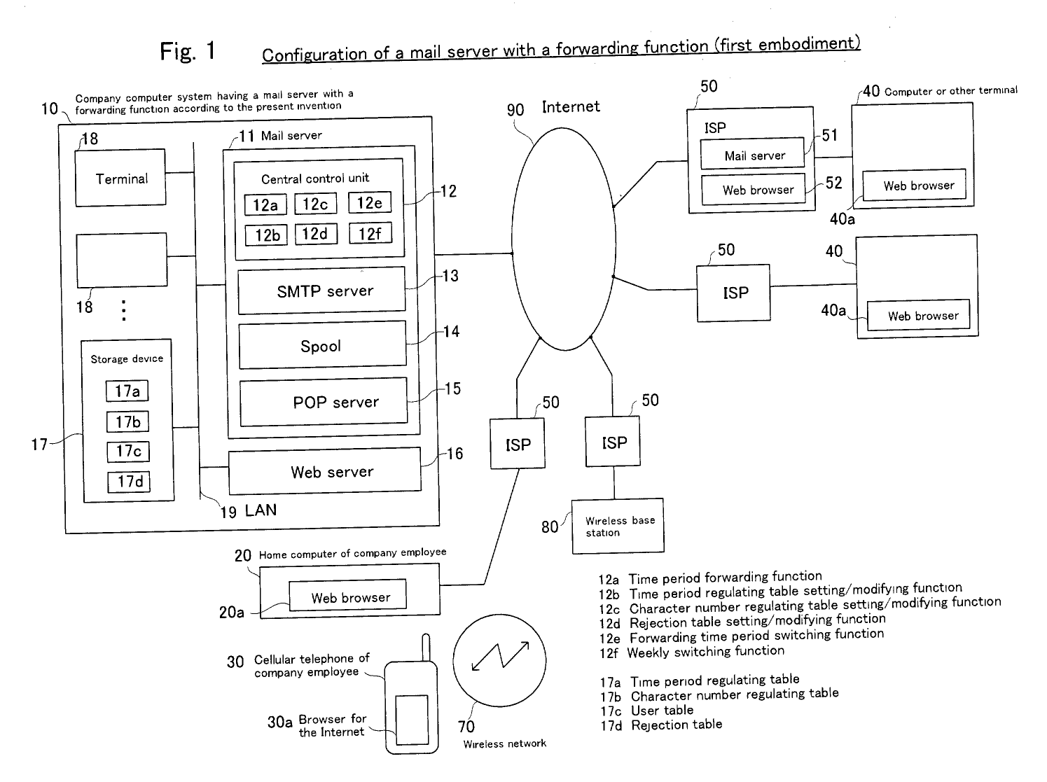

FIG. 1 shows the construction of a mail server with a forwarding function according to a first embodiment of the present invention.

The system in FIG. 1 includes a company computer system 10 at the user's place of employment, the system having a mail server with a forwarding function according to the present invention; a home computer 20 belonging to the user (company employee) provided with a web browser 20a; a cellular telephone 30 belonging to the company employee and provided with a browser 30a for browsing the Internet; terminals 40, such as personal computers for transmitting e-mail to the employee or for receiving e-mail sent from the employee, each comprising a web browser 40a; conventional Internet service providers (ISP) 50 each comprising at least a conventional mail server 51 and a web server 52; an Internet 90; a wireless base station 80; and a wireless network 70 connecting the cellular telephone 30 and wireless base station 80.

Next, the configuration of the company computer system 10 will be described. The company computer system 10 has a mail server with a forwarding function according to the present invention.

The company computer system 10 comprises at least a mail server 11, a web server 16, a storage device 17, terminals 18, and a LAN 19.

The mail server 11 includes a central control unit 12, a simple mail transfer protocol (SMTP) server 13, a spool 14, and a Post Office Protocol (POP) server 15.

In response to a transfer request from the terminal 18, the SMTP server 13 receives e-mail from the terminal 18 and forwards that e-mail to a destination mail server, such as the conventional mail server 51 of the ISP 50. The e-mail is stacked on the spool of the conventional mail server 51. A user of the terminal 40 can connect to the ISP 50 and receive e-mail on the spool at any time.

Similarly, e-mail transmitted from a computer, such as the terminal 40, is stacked on the spool of the conventional mail server 51. When the destination address of the e-mail is the company computer system 10, the SMTP server 13 receives the e-mail and stacks the e-mail on the spool 14.

The POP server 15 can transmit this e-mail to the terminal 18 at anytime, whenever an access request for receiving e-mail is received from the terminal 18. The central control unit 12 controls the above operations.

Next, the configuration of the company computer system 10 according to the present invention will be described in more detail.

The tables described below are prestored in the storage device 17. The storage device 17 is provided with a forwarding time period regulating table 17a for storing settings that are recorded for each of one or more destination terminals belonging to each user (company employee). In FIG. 1, the destination terminals include the home computer 20 and the cellular telephone 30 belonging to the employee. The time period regulating table 17a stores settings that regulate a prescribed forwarding time period during the 24-hour period of each day for corresponding mail addresses or terminals.

The storage device 17 further comprises a character number regulating table 17b for storing values that regulate the forwarded e-mail to a prescribed number of characters for each destination terminal individually.

The storage device 17 further comprises a user table 17c for storing passwords for each user required for accessing the time period regulating table 17a and character number regulating table 17b as a user. The storage device 17 further comprises a rejection table 17d for setting whether or not incoming e-mail should be forwarded to the terminals listed in the forwarding time period regulating table 17a.

Next, the central control unit 12 for controlling the mail server 11 will be described. The central control unit 12 comprises the following functions 12a, 12b, 12c, 12d, 12e, and 12f.

When e-mail addressed to the user is received via the LAN or the Internet 90, the time period forwarding function 12a references the time period regulating table 17a, reads the forwarding time period for each forwarding destination terminal of the user (the home computer 20 and cellular telephone 30 in the present example) and the current time of the computer system, and also references the rejection table to determine whether the incoming e-mail falls within the forwarding conditions. If the e-mail does fall within the forwarding conditions, the time period forwarding function 12a forwards the e-mail to the ISP 50 of the terminal listed as the forwarding destination for the current time period.

When receiving an access request from a user to set or update the forwarding time period for the home computer 20 and cellular telephone 30, the forwarding time period regulating table setting/modifying function 12b prompts the user for a password, and authenticates the password based on the user table 17c. If the password is authenticated, the function 12b receives a forwarding time period set by the user and writes the time period to the time period regulating table 17a.

After receiving an access request to set or update the number of forwarding characters for the home computer 20 and cellular telephone 30, the character number regulating table setting/modifying function 12 c prompts the user for a password, and authenticates the password based on the user table 17c. If the password is authenticated, the function 12c receives a number of forwarding characters set by the user and writes this number to the character number regulating table 17b.

The rejection table is provided to record a forward rejection object header and forward rejection character array specified by the user. When an access request is received for setting or updating data in the reject file, the rejection table setting/modifying function 12d prompts the user for a password, and authenticates the password based on the user table 17c. If the password is authenticated, the function 12d receives a forward rejection header and character array specified by the user and writes this data to the rejection table 17d.

The forwarding time period switching function 12e performs settings for specific days or days of the week based on data set by the user after the user's password is authenticated. With this function, the user can set a forwarding time period in the time period regulating table 17a to OFF for a specific date or day of the week (for example Sunday or Saturday and Sunday) by attaching an invalid code (OFF) next to the forwarding time in the time period regulating table 17a or can set this forwarding time period to ON by attaching an all times valid code (ON) to that date in the time period regulating table 17a, indicating that e-mail should be forwarded to the specified terminals.

The weekly switching function 12f further sets the forwarding time period in the time period regulating table 17a for fixed weekly days, such as nonworking days, set by the user after the user's password has been authenticated. In this way, the user can set a forwarding time period in the time period regulating table 17a to be invalid for specified weekly days by attaching an invalid code (OFF) next to the forwarding time in the time period regulating table 17a or can set this forwarding time period to ON by attaching an all times valid code (ON) to that day in the time period regulating table 17a, indicating that e-mail should be forwarded to the specified terminals.

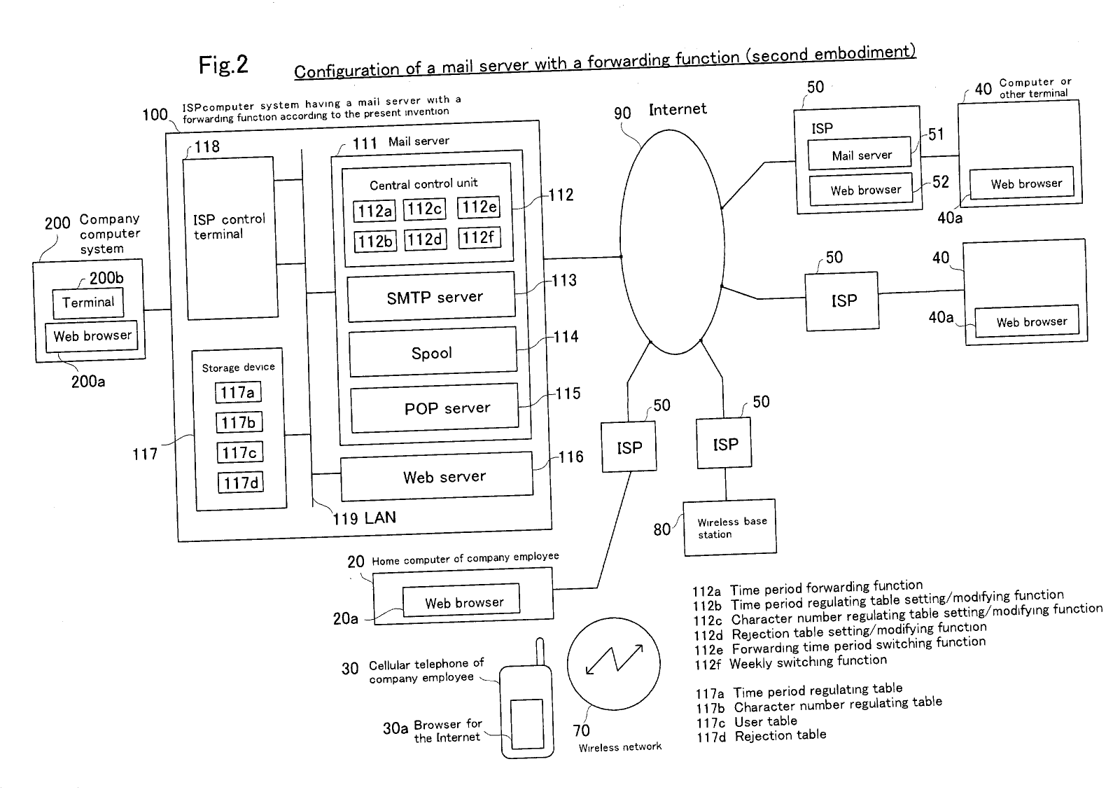

FIG. 2 shows the construction of a mail server with a forwarding function according to a second embodiment of the present invention.

Here, components 20, 30, 40, 50, 70, 80, and 90 have the same numerals and the same functions as those described in FIG. 1. Therefore, a description of these components has been omitted in the second embodiment.

In addition to these components, the second embodiment includes an ISP computer system 100 having a mail server with a forwarding function according to the present invention; and a company computer system 200 at the user's place of employment, provided with at least a web browser 200a. The ISP computer system 100 comprises a mail server 111, a web server 116, a storage device 117, an ISP control terminal 118, and a LAN 119.

While the embodiment of FIG. 1 includes a company computer system having a mail server with a forwarding function according to the present invention, the embodiment of FIG. 2 is a mail server with a forwarding function according to the present invention provided in an ISP with which the company computer system is contracted.

Accordingly, the portions of the ISP computer system 100 related to the mail forwarding function are substantially the same as those in the company computer system 10 of FIG. 1. Tables 117a, 117b, 117c, and 117d of the storage device 117 are the same as the tables 17a, 17b, 17c, and 17d of the first embodiment. Functions 112a, 112b, 112c, 112d, 112e, and 112f are the same as the functions 12a, 12b, 12c, 12d, 12e, and 12f of the first embodiment. In the first embodiment, however, the user transmits and receives e-mail with the terminal 18, while in the second embodiment the user transmits and receives e-mail with a terminal 200b in the company computer system 200.

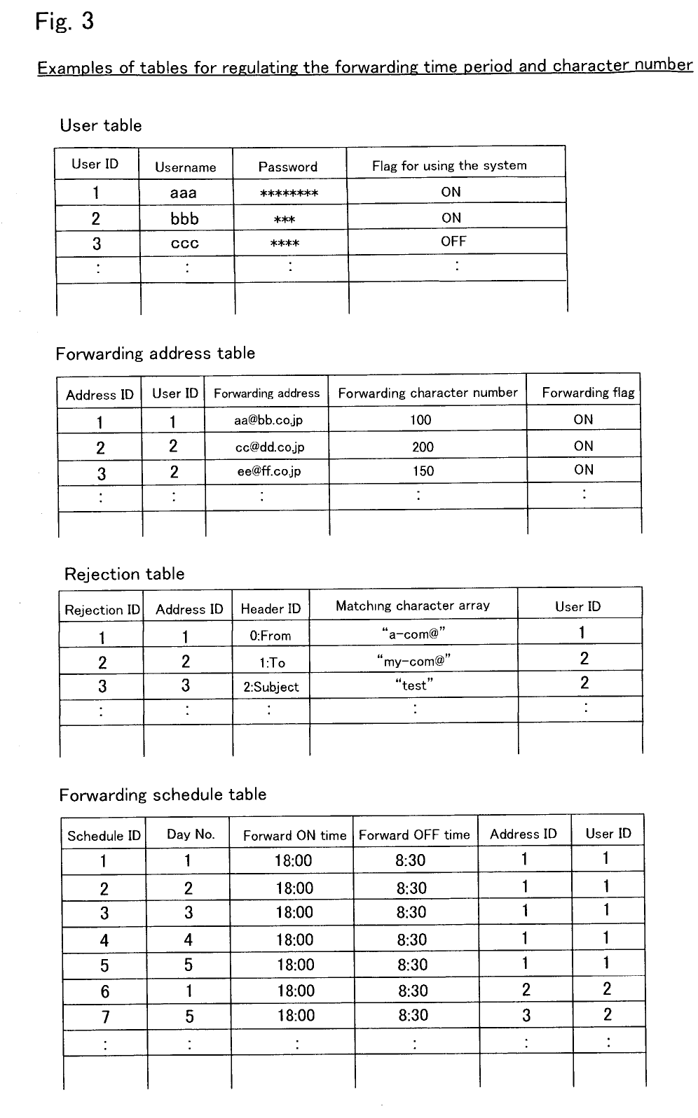

FIG. 3 shows some specific examples of tables for regulating forwarding time periods and numbers of characters. The examples shown here are a user table, a forwarding destination address table, a rejection table, and a forwarding schedule table.

A forwarding mail address for a home computer, cellular phone, and portable terminal (lap top computer, etc.) belonging to each company employee is indicated for each user.

A forwarding time period is also specified for regulating the time for forwarding e-mail to each terminal. It is possible to specify whether or not to forward e-mail to each terminal on specific days of the week. For example, the user can specify not to forward e-mail on Sundays when the user is not working or to forward e-mail on both Saturdays and Sundays. If the user sets e-mail to be forwarded, the e-mail is forwarded within the forwarding time period set for each day.

The number of characters that can be transferred is also indicated for each terminal. Here, the number of bytes of data is specified for each portable terminal.

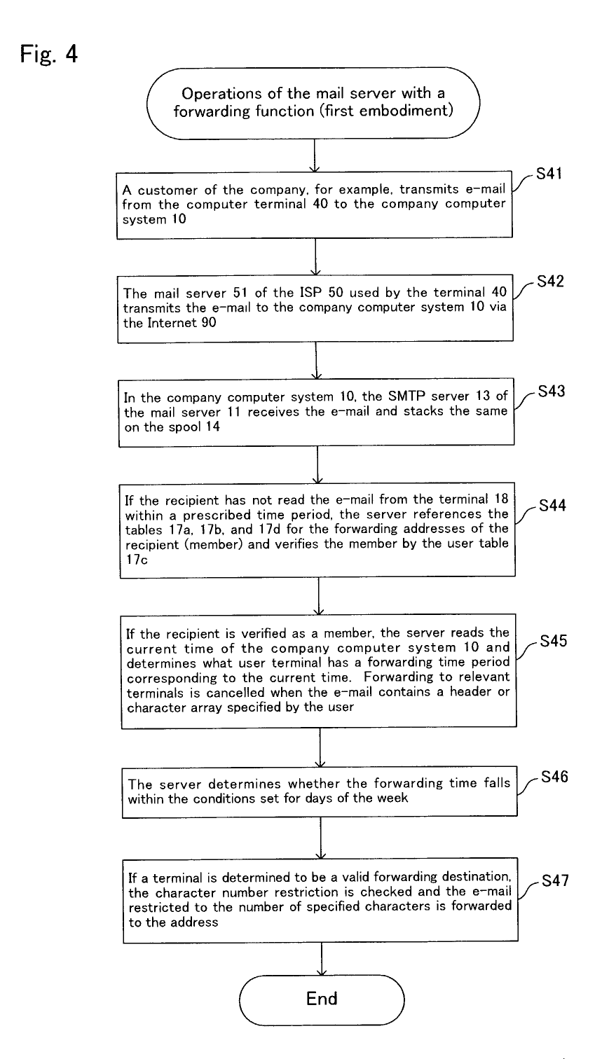

Next, the operations of the mail server with a forwarding function will be described with reference to the flowchart in FIG. 4. This flowchart described operations performed by the mail server of the first embodiment. More specifically, operations of the time period forwarding function 12a will be described in detail.

In this operation, e-mail is transmitted to specified forwarding addresses according to settings for each terminal in the time period regulating table 17a and character number regulating table 17b that are set by the user (company employee) E-mail specified in the rejection table 17d is not transmitted to the forwarding address.

Here, the company employee can access the company computer system 10 at any time by inputting a password from any of the terminal 18, home computer 20, or cellular telephone 30 in order to modify settings (functions 12b, 12c, and 12d).

The user can modify the forwarding day, forwarding time period, and the like (functions 12e and 12f). These modifications determine whether e-mail is forwarded or not forwarded, or change the forwarding time period and the like determined for each day.

Further, programs for the functions 12a, 12b, 12d, and 12e and data for the tables 17a and 17b used by the mail server 11 in FIG. 1 are stored as a single package on a recording medium. This recording medium can be transferred to another computer system when necessary to make the computer system operate as a mail server with a forwarding function according to the present invention.

The mail server with a forwarding function according to the present invention, and the recording medium storing programs for the same, has the following effects.

When a company mail server provided at a place of employment or an ISP mail server having a contract with the company is used as a mail server with a forwarding function according to the present invention, each user can enter detailed settings for forwarding e-mail to each of the user's terminals. These settings can account for the user's working status or nonworking status, such as days off. Accordingly, the present invention enables a more efficient use of a plurality of computer terminals.

The settings determine the forwarding time period for each day. Hence, the present invention provides an efficient method for establishing a schedule that determines whether to forward or not forward e-mail to various terminals on specific days of each week.

The user can access and modify these settings at any time from any of a plurality of the user's terminals, such as a home computer, cellular telephone, and portable computer terminal, provided authentication is received via a password.

By enabling the user to perform settings in this way, the following effect is obtained. Take for example e-mail addressed to the user that is to be simultaneously stored on the mail server and transferred to a terminal connected to the ISP mail server system in which the user has a cellular telephone contract. Here, the user sets a byte number for regulating the size of the e-mail in the character number regulating table because large e-mail messages with attached files or the like would cause problems if transferred to a cellular telephone, for example. By setting the byte number in this way, only the subject lines of the e-mail are displayed in the cellular telephone. The user can then check all e-mail on the user's computer system terminal after returning to the office.

On days off, the user can receive e-mail under favorable forwarding conditions based on the user's conditions at work and home, and other factors.

What is claimed is:

1. A mail server with a forwarding function for simultaneously forwarding incoming e-mail addressed to a user to the user's forwarding address and storing the e-mail temporarily on a spool, the mail server with a forwarding function comprising:
a forwarding time period regulating table storing an e-mail address for each of one or more user terminals used as destinations for forwarding e-mail and storing settings for regulating a prescribed forwarding time period corresponding to each e-mail address or terminal for the 24 hour period of each day;
a character number regulating table storing settings for regulating the number of characters in e-mail forwarded to each terminal;
a user table storing a password for each user required for accessing the time period regulating table and the character number regulating table as a user;
a rejection table recording user-specified forwarding rejection headers and forward rejection character arrays that are referenced when reading the header portions of incoming e-mail;
time period forwarding means for referencing the time period regulating table when e-mail addressed to the user is received via a LAN or an internet, reading the forwarding time period for each forwarding destination terminal of the user and the current time, and forwarding the e-mail to a computer system belonging to the Internet service provider of each terminal having a forwarding time period in which the current time falls;
forwarding time period regulating table setting/modifying means for prompting the user for a password and authenticating the password based on the user table when an access request to set or update the forwarding time period for the user terminals is received and for receiving a forwarding time period specified by the user and writing the time period to the forwarding time period regulating table if the password is authenticated;
character number regulating table setting/modifying means for prompting the user for a password and authenticating the password based on the user table when an access request to set or update the forwarding character number for the user terminals is received and for receiving a forwarding character number (byte number) specified by the user and writing the number to the character number regulating table if the password is authenticated;
rejection table setting/modifying means for prompting the user for a password and authenticating the password based on the user table when an access request to set or update data in the rejection table for incoming e-mail is received and for receiving a forwarding rejection header and forwarding rejection character array specified by the user and writing the data to the rejection table if the password is authenticated; and
forwarding time period switching means for setting the user-specified forwarding time period to be invalid for specific dates or days of the week specified by the user or to be valid for the entire day on the specific dates or days of the week after the user's password has been authenticated.

2. A mail server with a forwarding function as recited in claim 1, wherein the forwarding time period switching means further comprises monthly switching means for setting the user-specified forwarding time period to invalid or to valid for the entire day for user-specified days of the month, such as nonworking days, after the user's password has been authenticated.

3. A mail server with a forwarding function as recited in claim 1 or claim 2, wherein the mail server is a company computer system at the user's place of work; one of the destination terminals to which e-mail is forwarded is connected to a mail server system of an ISP with which the user is contracted to use a home computer with a web browser; another destination terminal to which e-mail is forwarded is connected to an ISP mail server system with which the user is contracted to use a cellular telephone having an Internet web browser; the forwarding time period for forwarding e-mail to the home computer is set to nonworking hours; and the forwarding time period for forwarding e-mail to the cellular telephone is set to working hours.

4. A mail server with a forwarding function as recited in claim 3, wherein the user can modify the number of characters of e-mail that can be forwarded to the home computer and the cellular telephone.

5. A mail server with a forwarding function as recited in claim 1 or claim 2, wherein the mail server is provided in a company computer system at the user's place of work or in a computer system of an ISP with which the user's company is contracted; one of the destination terminals to which e-mail is forwarded is connected to a mail server system of an ISP with which the user is contracted to use a home computer with a web browser; another destination terminal to which e-mail is forwarded is connected to an ISP mail server system with which the user is contracted to use a cellular telephone having an Internet web browser; the forwarding time period for forwarding e-mail to the home computer is set to nonworking hours; and the forwarding time period for forwarding e-mail to the cellular telephone is set to working hours.

6. A mail server with a forwarding function as recited in claim 5, wherein the user can modify the number of characters of e-mail that can be forwarded to the home computer and the cellular telephone.

7. A storage medium storing programs for a mail server with a forwarding function, comprising the time period forwarding means, the forwarding time period regulating table setting/modifying means, the character number regulating table setting/modifying means, the rejection table setting/modifying means, and the forwarding time period switching means used by the mail server with a forwarding function of claim 1.
